(19) United States
(12) Patent Application Publication
(10) Pub. No.: US 2013/0031814 A1
(43) Pub. Date: Feb. 7, 2013

(54) Curved Motorcycle License Plate Frame, Illuminated From Behind The Frame

(71) Applicant: Kenneth Wayne Puccio, Flagstaff, AZ (US)

(72) Inventor: Kenneth Wayne Puccio, Flagstaff, AZ (US)

(21) Appl. No.: 13/525,260

(22) Filed: Jun. 15, 2012

Related U.S. Application Data
(63) Continuation of application No. 12/753,847, filed on Apr. 2, 2010, now abandoned.

(51) Int. Cl. B60R 11/00

(52) U.S. Cl. 40/204

(57) ABSTRACT

This invention relates to motorcycles and more specifically custom motorcycles that have added a special rear fender that has a curved license plate recess that is built into it. This license plate frame is curved and fits into the recess of the custom fender that is located away from the taillight which traditionally is the light source for the license plate. The license plate that it surrounds is illuminated independently by waterproof flexible strips of white light LED's that are attached with an automotive grade double sided tape to the inside edge of the frame and because they are flexible, take the curved shape of the frame. The LED's are spliced into the vehicle's tail light wiring system and are energized from the motorcycle battery when the tail light is on.

### CONTINUITY DATA

This is a continuation application of patent application Ser. No. 12/753847.

### FRAME REFERENCES CITED

U.S. Pat. No. 154,631 July 1925 Smith

U.S. Pat. No. 1,887,087 November 1932 Frazier

U.S. Pat. No. 2,526,460 October 1950 Crocella

U.S. Pat. No. 2,875,539 March 1959 Gladd

U.S. Pat. No. 4,857,890 August 1989 Solow

D327,915 July 1992 Anderson et al

U.S. Pat. No. 6,874,922, April 2005 Matsuura, et al

### FIELD OF THE INVENTION

This invention relates to motorcycles and more specifically custom motorcycles that have have added a special rear fender that has a curved license plate recess that is built into it. This license plate frame is curved and fits into the recess of the custom fender, typically on a cruiser style motorcycle or a curved license plat bracket relocater often on sport bikes, that is located away from the taillight which is the light source for the license plate. The license plate frame may be formed from plastic or any metal including zinc, aluminum and steel. The license plate that it surrounds is illuminated independently by waterproof flexible strips of white light LED's that are attached with an automotive grade double sided tape to the inside edge of the frame. The LED's are spliced into the vehicle's taillight wiring system and are energized from the motorcycle battery when the taillight is on.

### BACKGROUND OF THE INVENTION

Typically motorcycle license plate frames and the plate itself is flat and mounted on a bracket that is attached to the motorcycle and is illuminated through a clear portion of the taillight lens. Part of the problem with a curved license plate and frame is illuminating it bright enough at night. Special mounting hardware used in the four comers of the plate and frame with single LED's have been used but are sometimes not bright enough to satisfy state vehicle codes. Furthermore design schemes such as planar lighting or use of light pipe as in some of the references disclosed herein will inherently require more lighting sources and more electrical power than the invention disclosed herein. Lighting on a traditional flat license plate are not as problematic, utilizing a rigid straight line light mounting system. Approaches to lighting a surface, such as planar lighting, are inherently less efficient than the invention disclosed herein when applied to a curved surface. This invention utilizes flexible strips of LED's that are easily adapted to the curvature of the license plate frame and emit plenty of light to directly light the surface and satisfy legal requirements.

### SUMMARY OF THE INVENTION

This invention is intended to satisfy legal requirements of the States they are used in by emitting a bright light. It is also intended to light the license plate from the inside edge of the license plate frame independently of the motorcycle taillight and give the motorcycle a custom look when using an after market wide fender that has a built in curved license plate and frame recess. Insufficient night time lighting is solved using flexible LED mounting strips that contain more lights than the traditional single lights used in the four mounting corners. Custom wide fenders have become increasingly popular among the heavy cruiser style motorcycle enthusiast and are being manufactured by several companies. This invention is a perfect compliment to these custom fenders.

### DESCRIPTION OF THE INVENTION

In certain embodiments the number of LED's may be as few as two and as high as seventy, however these particular embodiments are not meant to limit the many permutations of the invention. Certain preferred embodiments are from three up to twenty four LED's. In one embodiment 335 SMD side emitting flexible strips are used, with two alternative embodiments of either 12 or 24 LED's depending on desired brightness. Currently the legal requirement in most states, for example California, Virginia, West Virginia, Oregon, North Carolina, Illinois, Washington state, Utah, Texas, Indiana, Kansas, Maryland, Michigan, New Hampshire, New Mexico, Ohio, and Alaska, is that a license plate be sufficiently lighted to be clearly visible and legible from a distance of at least 50 ft. The present invention shall be construed to be and is capable of achieving the legal limit in each of the fifty states, and inherently by it's design does so more efficiently than other devices utilizing for example planar lighting or a light pipe. It is further an inherent characteristic and advantage of the invention, that it need not use either planar lighting or the aid of a light pipe as disclosed in U.S. Pat. No. 6,874,922, Matsuura, et al. The ability of the LED's to illuminate the license plate up to the legal standards of the States, is obvious based on the design scheme shown in the figures. It is further obvious to one of ordinary skill in the art the inventions design would not require planar lighting or a light pipe such as those disclosed in Matsuura, et al. Planar lighting utilizes either back lit or edge lit led arrangements. Back lighting is not useful with a solid object such as a license plate, and an edge lit LED arrangement requires a surface area to direct and uniformly disperse the light, whereas the current invention uses direct lighting from the LEDs themselves. Planar lighting if tried through a curved piece of glass or other material will be much less efficient at lighting the surface of the plate as it is opposite the direction of the curvature and the direction of the light, and significant light will be lost traveling outward beyond the curve as the light travels straight while the glass over covering bending inward. Further, as the LEDs in current invention are not contained, other than their individual casings, in a continuous and opaque or clear enclosure they inherently do not constitute or require the implementation of a light pipe as has been used before. It is further an object of the current invention to provide the lighting required to meet the legal minimum in the States with a smaller number LED's, or an overall lower amount of electricity used by a plurality of LED's, than would be required to do so in a design scheme involving planar lighting or light pipes. The design in Matsuura, et al, is inadequate to function as the current invention as the lighting schemes disclosed in that reference when used on a curved surface, would require a much greater number of LED's and electrical power than does the current invention. A major advantage of the current invention is it's ability to better illuminate over a curved surface. In one embodiment the invention fits into a recess on a special rear fender. In other embodiments where there is no recess the invention is attached directly to the curvature of the special rear fender.

### BRIEF DESCRIPTION OF THE DRAWINGS

FIG. 1. is a front perspective view showing the curvature of the motorcycle license plate frame.

FIG. 2. is a rear view, but for illustration purposes it is depicted as FLAT without any curve.

### DETAILED DESCRIPTION OF THE DRAWINGS

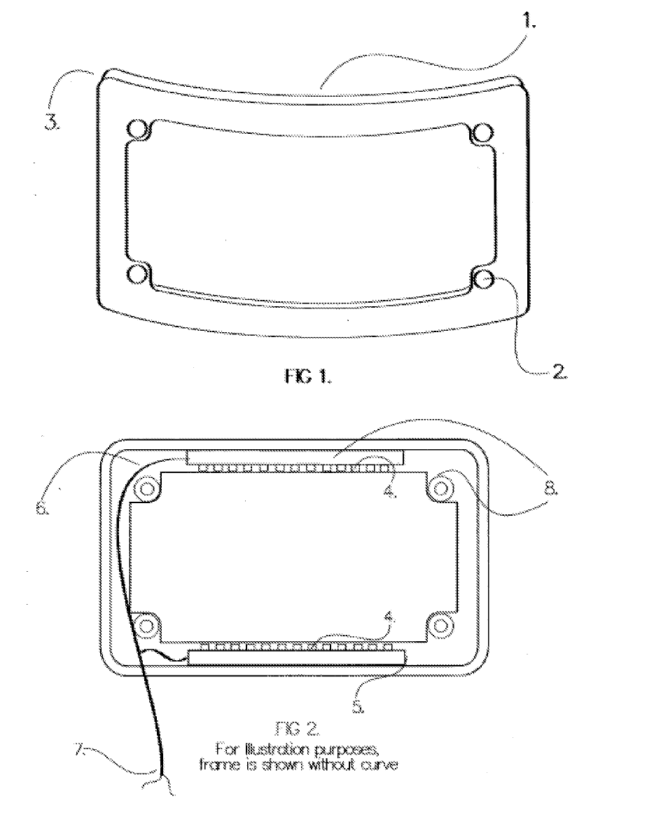

FIG. 1. #1 shows the curvature of the license plate frame that will match the curve of a wide custom motorcycle fender. The curvature is equal on both top and bottom.

FIG. 1. #2 shows the four mounting holes that the frame is mounted to the license plate and fender.

FIG. 1. #3 shows the width of the frame, approximately 1 inch on top and 3/1 inch on the bottom. This conceals the LED lights that are mounted behind. The sides are about ½ inch wide to conceal the electrical wires to the LED's.

FIG. 2. #4 shows two rows of LED's, one each top and bottom. These strips are the heart of the invention because they are flexible and are partly embedded in silicone to make them waterproof.

FIG. 2. #5 shows the silicone type material the lights are embedded in. This also shows the automotive grade double sided tape the is used to attach the LED's to the license plate frame. This tape is the same type that attach chrome and trim to the outside of car panels. Very strong.

FIG. 2. #6 are the double insulated electrical supply wires.

FIG. 2. #7 are the 12 volt electrical leads that are spliced into the motorcycles taillight for power.

FIG. 2. #8 is a dotted rectangular line that depicts the installed license plate in back of the upper and lower row of LED's approximately 1/1 inch behind the frame. Nylon spacers around the mounting screws an be used to fill this gap. In use, the license plate frame provides both illumination for the license plate and enhanced aesthetic appeal. Additionally, the use of many LED's provides extra visibility to other motorists after dark. While the invention has been illustrated and described in detail in the drawings and foregoing description, the same is to be considered as illustrative and not restrictive in character, it being understood that only the preferred embodiment has been shown and described in detail and that all changes and modifications that come within the spirit of the invention are desired to be protected.

I claim:

1. A license plate frame comprising: a solid material delimiting a substantially rectangular shape having an opening therein, wherein said solid material is curved in at least one plane; a plurality of light emitting diodes attached to at least a portion of said solid material; and a series of electrical conductors connecting said light emitting diodes in a direct current circuit.

2. A license plate frame as set forth in claim 1, wherein the light emitting diodes (LED) incorporates a waterproof flexible strip circuit board and silicon technology.

3. A license plate frame as set forth in claim 1 wherein the material from which it is constructed is of a thickness to be flexible and interchangeable to other vehicles.

4. A license plate frame as set forth in claim 1 wherein the a material from which it is constructed is rigid.

5. A license plate frame as set forth in claim 1, wherein the material from which it is constructed is metal or plastic or carbon fiber.

6. A license plate frame as set forth in claim 1 wherein illumination to the license plate is provided directly by the plurality of LEDS without a light pipe.

7. A license plate frame as set forth in claim 1 wherein illumination to the license plate is provided directly by the plurality of LED's without planar lighting.

8. The illumination of a license plate wherein the light emitting diodes (LED) incorporates a waterproof flexible strip circuit board and silicon technology without the use of planar lighting or a light pipe.

9. The illumination of a license plate with the device of claim 1, wherein the light emitting diodes (LED) incorporates a waterproof flexible strip circuit board and silicon technology without the use of planar lighting or a light pipe.

10. The illumination of a license plate according to claim 1, wherein the amount of electrical power used to meet the legal requirement is less than required in the use of planar lighting or a light pipe.

11. The illumination of a license plate according to claim 1, wherein the amount of light emitted to meet the legal requirement is less than required in the use of planar lighting or a light pipe.

12. The illumination of a license plate according to claim 1, wherein the number of LED's needed to meet the legal requirement is less than required in the use of planar lighting or a light pipe.

13. The illumination of a license plate according to claim 1, wherein the amount of electrical energy or number of LED's used to illuminate a curved surface is less than required in the use of planar lighting or in the use of a light pipe.

14. The device of claim 9, wherein said device is attached to a special rear fender of a cruiser style motorcycle.

15. The device of claim 9, wherein said device is attached to a recess on a special rear fender of a cruiser style motorcycle.

16. A license plate frame that is attached to a recess on a special rear fender of a cruiser style motorcycle said license plate frame comprising:
a solid material delimiting a substantially rectangular shape having an opening therein, wherein said solid material is curved in at least one plane; a plurality of light emitting diodes attached to at least a portion of said solid material; and
a series of electrical conductors connecting said light emitting diodes in a direct current circuit.

17. The license plate frame of claim 16, wherein the light emitting diodes (LED) incorporates a waterproof flexible strip circuit board and silicon technology without the use of planar lighting or a light pipe.

18. Claim 17, further comprising using the minimal amount of electrical energy for the plate to be visible at fifty feet in darkness.

19. Claim 9, wherein said device is attached to a curved license plate bracket relocater on a sport bike.

20. Claim 18, wherein said device is attached to a recess on a special rear fender of a cruiser style motorcycle.
